(19) United States
(12) Patent Application Publication
(10) Pub. No.: US 2006/0147631 A1
(43) Pub. Date: Jul. 6, 2006

(54) Method for making diamond coated substrates, articles made therefrom, and method of drilling

(76) Inventors: Leonid C. Lev, West Bloomfield, MI (US); Michael J. Lukitsch, Marysville, MI (US); Yang-Tse Cheng, Rochester Hills, MI (US); Anita M. Weiner, West Bloomfield, MI (US)

Correspondence Address: KATHRYN A MARRA;General Motors Corporation, Mail Code 482-C23-B21, P.O. Box 300, Detroit, MI, 48265-3000, US

(21) Appl. No.: 11/028,893

(22) Filed: Jan. 4, 2005

(51) Int. Cl. B05D 3/12

(52) U.S. Cl. 427/290; 29/527.4

(57) ABSTRACT

Disclosed is a method of making a coated substrate, especially a diamond coated substrate. In one embodiment, the method includes depositing an interlayer on a substrate to create an interlayer surface, peening the interlayer surface with a peening compound to create a peened interlayer surface, and depositing a coating on the peened interlayer surface to create a coated substrate wherein the peening compound comprises particles of the coating. Also provided is a method of drilling a nonferrous substrate such as aluminum with no more than minimum lubricants. The method includes providing a diamond coated drill produced by the foregoing method, and moving the drill against a nonferrous substrate under sufficient force such that the drill cuts and removes a portion of the substrate, wherein the moving of the drill against the substrate occurs under minimum lubrication conditions.

### TECHNICAL FIELD

The disclosed methods relate to the production of diamond coatings and films on metallic substrates and articles. In one embodiment, the disclosed methods relate to the production of diamond coatings on articles used to drill nonferrous substrates such as aluminum.

### BACKGROUND OF THE INVENTION

Articles or substrates having diamond coatings or films are of interest for a number of reasons. Diamond coatings or films typically may exhibit one or more desirable properties such as very high hardness, high strength as measured by bulk modulus and compressibility, broad optical transparency from deep UV to far IR, good electrical insulator properties, biological compatibility, low coefficient of friction, high wear resistance, high thermal conductivity and chemical inertness.

Applications of interest for diamond coated substrates and articles include thermal management applications such as laser diodes and integrated circuits, cutting tools, wear resistant coatings, optics, electronic devices (for doped diamond coatings and films), and composite materials.

As a result, diamond coatings and films are of interest with respect to a number of different substrates, including steel, non-carbide forming substrates, carbide-containing substrates, sintered or cemented carbides, and the like.

In some applications, the diamond coated substrates or articles are subjected to conditions of increasing temperature, friction and shear forces. It would be advantageous to either minimize or avoid conditions such as coating delamination from the substrate, spalling, coating fracture and the like, which are sometimes attributed to insufficient adhesion between the surface substrate of the article and the diamond coating. Thus, some applications desire improvements in the adhesion of a diamond coating to an underlying substrate.

### SUMMARY OF THE INVENTION

Disclosed is a method of making a coated substrate on an article, especially a diamond-coated substrate. In one embodiment, the method provides a method of making a diamond coated carbide substrate on a drill.

In one exemplary embodiment, the method comprises depositing an interlayer on a substrate to create a interlayer surface, peening the interlayer surface with a peening compound comprising friable particles to create a peened interlayer surface, and depositing a coating on the peened interlayer surface to create a coated substrate.

In another embodiment, the disclosed method for making a coated substrate on an article comprises depositing an interlayer comprising Cr/CrN on a substrate comprising WC to create a interlayer surface, peening the interlayer surface with a peening compound comprising friable diamond particles to create a peened interlayer surface, and depositing a diamond coating on the peened interlayer surface to create a coated surface.

Also provided is a method of drilling a nonferrous aluminum with no more than minimum lubricants. In one embodiment, the method comprises providing a diamond coated drill produced by the disclosed methods and rotating the drill against a nonferrous aluminum substrate under sufficient pressure and force such that the drill creates displacement in the substrate, wherein rotating the drill occurs under minimum lubrication conditions. In one exemplary embodiment, the rotation of the drill will occur with substantially no lubricants.

### BRIEF DESCRIPTION OF THE DRAWINGS

FIG. 1 is a side view of one embodiment of the disclosed invention.

FIG. 2 is a side view of another embodiment of the invention.

FIG. 3 is a side view of a third embodiment of the invention.

FIG. 4 is a microphotograph of a Rockwell indent on a diamond coating on a non-peened Cr/CrN/WC substrate, illustrating the modes of failure.

FIG. 5 is a microphotograph of a Cr interlayer after peening with diamond powder.

FIG. 6 is a microphotograph of a Rockwell indent on the diamond-coated surface of FIG. 5.

### DESCRIPTION OF THE PREFERRED EMBODIMENT

In one embodiment, the disclosed method of making a coated substrate on an article comprises depositing an interlayer on a substrate to create a interlayer surface, peening the interlayer surface with a peening compound to create a peened interlayer surface, and depositing a coating on the peened interlayer surface to create a coated substrate, wherein the peening compound comprises particles of the coating. In one exemplary embodiment, the method provides a method of making a diamond coated carbide substrate on a cutting tool and a method of dry drilling.

Suitable substrates for use in the disclosed method will generally have a melting point higher than about 1000-1400 K, i.e., the temperature required for diamond growth and may include metallic and nonmetallic substrates. In one exemplary embodiment, the substrate will comprise a material useful in the shaping of articles of complex geometry, such as drills and drill bits.

Illustrative examples of suitable nonmetallic substrates include those based on Si or B as well as compounds such as SiO₂, quartz, and Si₃N₄, and the like, while suitable metallic substrates include ferrous and nonferrous alloys. Illustrative examples of suitable ferrous-based alloys include steel, such as tool steel, and the like. In one embodiment, the substrate will be tool steel. Tool steels are steel capable of attaining high levels of hardness and preserving this hardness under high temperature. These steels usually have a high content of carbon, close to 1% and may comprise one or more of a number of carbide-forming metals, such as W, V, Cr, Mn, and the like. Suitable nonferrous alloys include those comprised of one or more metals such as Ti, Zr, Hf, V, Nb, Ta, Cr, Mo, W, Fe, Co, Ni, Y, Al, other rare earth metals, as well as carbide based substrates such as WC and TiC. In one embodiment, the substrate will be cemented carbide. Cemented carbide refers to a composite material comprising hard grains of ceramic, usually WC, TaC, TiC or others, held together by a metallic matrix, usually Co, Ni or Cr. In one exemplary embodiment, the substrate will be a cemented carbide comprising WC.

In one embodiment the substrate will be at least one surface of an article of complex geometry. Illustrative examples of suitable articles include cutting tools such as drills, drill bits, cutters, milling cutters, taps, and the like.

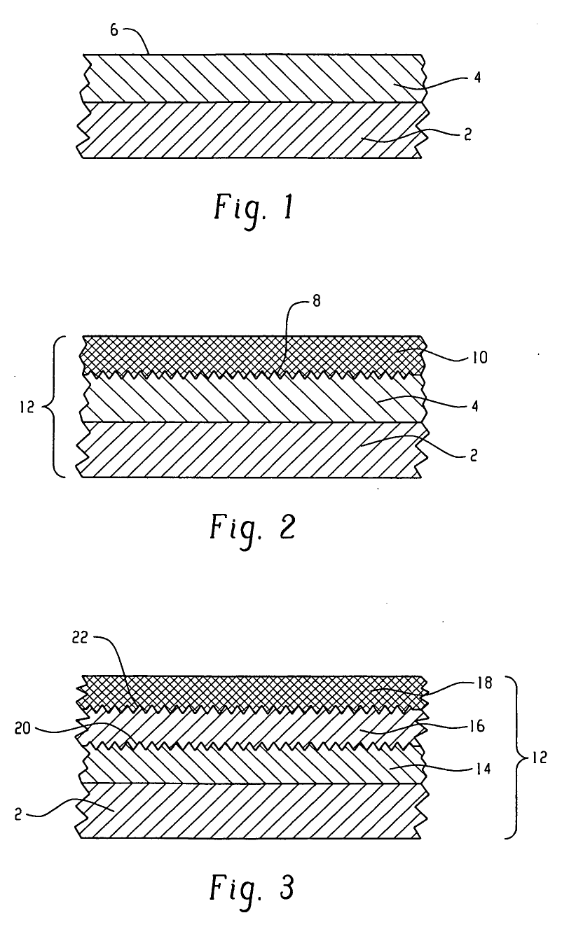

As indicated in FIG. 1, the disclosed method includes the deposition of an interlayer (4) on a substrate (2) to create an interlayer surface (6). FIG. 2 illustrates that interlayer surface (6) is peened as described below to create a peened surface (8). A coating (10) is then deposited on peened surface (8) to provide the coated substrate or article (12).

In one embodiment, suitable interlayers may be further characterized as those materials that are adherent to both the underlying substrate and the subsequently applied diamond coating. In yet another embodiment, suitable interlayers may be characterized as those materials that function to block or impede the diffusion of metals such as cobalt from the underlying substrate into the subsequently applied diamond coating. In one exemplary embodiment, suitable interlayers may be characterized as those materials that (i) do not form intermetallics with cobalt, (ii) are adherent to both the underlying substrate and the subsequently applied diamond coating, and (iii) function to block or impede the diffusion of metals such as cobalt from the underlying substrate into the subsequently applied diamond coating.

Illustrative examples of materials suitable for use as an interlayer or interlayer surface in the disclosed method include ceramics, metallics, and mixtures thereof. Illustrative examples of suitable metallic interlayers include Ti, W, Mo, Zr, Cr, CrN, CrCN, mixtures thereof, and the like. In one exemplary embodiment, a suitable interlayer material or interlayer surface will comprise Cr.

The interlayer may be deposited by any of the available techniques. In one embodiment, the interlayer will be deposited using at least one of chemical vapor deposition (CVD), plasma assisted chemical vapor deposition (PACVD), or carbon derived carbide method. In one exemplary embodiment, the interlayer will be deposited via PVD.

Additional techniques or processes may be used to change the composition of the deposited interlayer material to provide an interlayer surface that is different than the deposited interlayer. That is, the interlayer surface may be the same as or different from the deposited interlayer material. For example, in one exemplary embodiment, the interlayer will be Cr deposited by a PVD method, followed by nitriding to provide a interlayer surface of CrN.

The interlayer will generally be deposited on the substrate to provide an interlayer surface of at least 3 micron thick. In one embodiment, the interlayer surface will have a film build of from 3 to 6 microns.

In one embodiment as illustrated in FIG. 3, the interlayer (4) coated with a coating (18) may comprise one or more sub layers (14) and (16). The interlayer sub layers may be the same or different. In one embodiment, at least one sub layer will comprise a ceramic while at least one other sub layer comprises a metal. In one exemplary embodiment, a ceramic sublayer (14) will be closer to the substrate (2) than the at least one metallic sub layer (16).

The resulting interlayer surface is then peened with a peening compound. “Peening” as used herein refers to a process in which particles of peening compound are sent flying toward a surface and strike the surface with great force. In another words, peening is the technique of bombarding the surface with a high velocity stream of pre-selected particles.

During the peening process, the particles of peening compound are carried and accelerated by, and in, the jet of air or other gas. Accelerated particles move freely but with high velocity and speed toward the surface. When they reach the surface, they strike, hit and impinge on it with a substantial force. This force is determined by the speed at which the particles are directed toward the surface and increases as the particle speed increases. As a result of this impact the surface deforms, forming small dimples, scratches and craters. Also, as a result of this process the particles may fracture and some of the particles may penetrate the surface. Thus, in one embodiment, some particles of peeing compound may become embedded or impregnated in the peened surface.

The acceleration of the particles during the peening processes imparts substantial kinetic energy and momentum to them. Kinetic energy as used herein is energy associated with motion. Momentum as used herein is a property of a moving body that the body has by virtue of its mass and motion and that is equal to the product of the body's mass and velocity. This momentum is the reason for the force acting from the particle onto the surface. This kinetic energy is given up when particles strike the surface. It is consumed during the processes of surface deformation, possible particle fracture and penetration of particles into the surface.

The speed of particles in the peening process is determined by the speed of a carrier fluid that propels the particles. Examples of suitable carrier fluids include air or another gas. Increases in the speed or velocity of the carrier fluid result in corresponding increases in the speed or velocity of the particles.

During the peening process a large number of the peening compound particles are accelerated to high rate of speed and velocity in the carrier fluid, imparted with high kinetic energy and momentum and are sent flying toward the surface. They strike it and leave marks on it, such as small dimples or craters.

In one embodiment, at least 30% of the peened surface will be covered with craters formed as a result of impact of the particles of the peening compound. In another embodiment from 50 to 80% of the peened surface will be covered with craters formed by the particles of the peening compound.

In one embodiment, the carrier fluid will have a pressure of at least 30 psi. In one exemplary embodiment, the carrier fluid will have a pressure of from 30 to 100 psi, while in another embodiment; the carrier fluid will have a pressure of from 50 to 80 psi.

Illustrative examples of suitable peening compounds include diamond compounds, ceramics, metal nitrides such as boron nitrides, metal carbides, and mixtures thereof.

In one embodiment, the particles of peening compound will have an average hardness at least equal to or greater than the hardness of one of the interlayers (4).

In one embodiment, suitable peening compounds will comprise particles having an average particle diameter of at least 3 microns, while in another embodiment, suitable peening compounds will comprise particles having an average particle size of from 3 to 200 microns. In one exemplary embodiment, suitable peening compounds will comprise particles having an average particle diameter of from 30 to 150 microns, while in one especially exemplary embodiment, the peening compound will comprise particles having an average particle diameter of from 75 to 150 microns. In one embodiment, suitable peening compounds will have an average particle diameter of at least 3 microns, while in another embodiment; suitable peening compounds will have an average particle size of from 3 to 200 microns. In one embodiment, suitable peening compounds will comprise particles having an average particle diameter of from 30 to 150 microns, while in one especially exemplary embodiment, the peening compound will have an average particle diameter of from 75 to 150 microns.

In one exemplary embodiment, the peening compound will comprise particles of the coating to be subsequently applied to the peened interlayer surface. That is, the peening compound and the subsequently applied coating will comprise the same composition. For example, suitable peening compound particles may include diamond particles if the peened interlayer surface is to be subsequently coated with diamond, boron nitride particles if the peened interlayer surface is to be subsequently coated with boron nitride, and the like. In one exemplary embodiment, the peening compound will comprise diamond particles when the coating to be applied to a peened interlayer surface comprises a diamond coating.

In one embodiment, the peening compound used in the disclosed method will comprise friable particles. “Friable” as used herein refers to particles that can fracture and shear into smaller particles upon crystallographic lines upon impact with the surface after being propelled by the pressurized air jet with the pressure used for peening. Compounds comprising friable particle having an average particle diameter of at least 3 microns are especially suitable, with friable particles having an average particle diameter of from 75 to 150 microns being used in one exemplary embodiment.

Suitable friable particles may also be characterized by properties such as hardness, fracture toughness, and the presence of crystallographic defects facilitating fracture. For example, in one exemplary embodiment, suitable friable particles will be diamond grains sintered together with defects along the seams.

In one exemplary embodiment, the peening compound will comprise friable particles of the coating to be subsequently applied. That is, in one exemplary embodiment, the composition of the friable particles of peening compound and the subsequently applied coating are the same. Illustrative peening compounds include friable particles of diamond, boron nitride, mixtures thereof, and the like. In one exemplary embodiment, the peening compound will comprise friable diamond particles when the coating to be applied to the peened interlayer surface comprises a diamond coating.

In another embodiment, the disclosed method of making a coated substrate on an article further comprises depositing an interlayer to form an interlayer surface; peening the resulting interlayer surface with a first peening compound to form a first peened interlayer surface; peening the first peened interlayer surface with a second peening compound to form a second peened interlayer surface and repeating said peening process with one or more additional peening compounds to provide a repeatedly peened interlayer surface, and depositing a coating on top of the repeatedly peened surface to form a coated surface or substrate. The peening compounds used in such repeated peening may be the same or different, but in one embodiment will be different. Similarly, the repeated peening steps may be conducted at the same or different speeds or velocity. Such peening may be done per the foregoing description. For example, turning to FIG. 2, it can be seen that the surface (8) of interlayer (4) may be a repeatedly peened surface that is produced by sequential peening with either the same or different peening compounds.

Individual sub layers of an interlayer (4) may also be individually subjected to peening. For example, as illustrated in FIG. 3, the surface of first sub layer (14) may be peened with a first peening compound to provide a first peened interlayer surface (20), while the surface of sub layer (16) may be peened with a second peening compound (16) to provide a second peened interlayer surface (22). In one embodiment, the second peening compound will comprise particles of the coating (18). It will also be appreciated that one or both of peened surfaces (20) or (22) may be a repeatedly peened surface.

For example, in one embodiment, a first peening can be done in a peening apparatus for a duration of between 15 and 60 seconds with a first peening compound comprising diamond particles having an average diameter of 150 micron accelerated by an air pressure of between 25 psi and 50 psi to result in more than 60% of the surface being impacted; followed by a second peening with a second peening compound comprising diamond particles having an average diameter of 30 microns accelerated by an air pressure of between 80 and 90 psi for 60 seconds, to result in more than 85% of the surface impacted with the particles

In one embodiment, an optional step of seeding the peened interlayer with particles of the coating to be deposited may be employed. In one exemplary embodiment, the optional step of seeding the peened interlayer will be employed. For example, particles may be seeded on a substrate via submersion of the substrate in an ultrasound suspension containing the particles to be seeded. Seeding via ultrasonification may also be employed. In one exemplary embodiment, the particles to be seeded will have an average particle size of from 0.3 to 1.0 microns, while in another embodiment the seeding particles will have the average diameter of 0.5 microns.

The peening of the interlayer surface creates a peened interlayer surface upon which a coating is deposited to provide a coated substrate. Illustrative examples of suitable coatings include diamond coatings, ceramic coatings, coatings comprising metal nitrides such as boron nitrides, metal carbides and the like, as well as combinations thereof. In one exemplary embodiment, the coating is a diamond coating and the resulting coated substrate is a diamond coated substrate.

Diamond coating as used herein refers to both amorphous or polycrystalline diamond coatings or films prepared by at least one of chemical vapor deposition (CVD), plasma assisted chemical vapor deposition (PACVD), or carbon derived carbide method. In one exemplary embodiment, the coating will be a diamond coating deposited via PACVD. For example, in one embodiment, a diamond coating may be grown in a chamber at a temperature of between 700 and 850 degrees C., in an atmosphere of hydrogen and hydrocarbons such as acetylene, flowing under a pressure of between 3 to 9 millitor, in a micro-wave plasma atmosphere with an average charge density of 10¹⁵ charged particles per cubic centimeter.

In one exemplary embodiment, the disclosed method will relate to the production of diamond coated tungsten carbide substrates, especially sintered tungsten carbide substrates. In this case the disclosed method comprises depositing an interlayer comprising Cr/CrN on a substrate comprising WC to create an interlayer surface, peening the interlayer surface with a peening compound comprising friable diamond particles to create a peened interlayer surface, and depositing a diamond coating on the peened interlayer surface to create a coated surface.

In one exemplary embodiment, a method of diamond coating a substrate is disclosed, the method requiring depositing an interlayer comprising Cr/CrN on a substrate comprising WC to create a interlayer surface, peening the interlayer surface with a peening compound comprising friable diamond particles to create a peened interlayer surface, and depositing a diamond coating on the peened interlayer surface to create a diamond coated substrate.

In one embodiment, the coated substrate is a substrate of an article such as a cutting tool. Illustrative examples of cutting tools include drills, drill bits, milling cutters, turning cutters, cutter inserts, and the like. In one particularly exemplary embodiment, the coated substrate is a diamond coated cemented tungsten carbide substrate of a drill bit and the disclosed article is a drill or drill bit.

It has been found that cutting tools made according to the disclosed methods are of particular benefit in drilling or cutting nonferrous substrates comprising metals such as aluminum, magnesium, titanium, and the like.

In one embodiment, the disclosed articles may be used in a particular machining method known as dry or semi-dry machining wherein the tool is subjected to conditions of increasing temperature, friction and shear forces. Machining as used herein generally refers to processes wherein a cutting tool is moved against a substrate under sufficient force and pressure so as to create a displacement in the substrate. Illustrative machining processes include cutting and drilling.

Thus, there is also disclosed a method of machining a substrate, especially a nonferrous substrate, with no more than minimum lubricants, and in one exemplary embodiment, substantially without lubricants.

“Minimum lubrication conditions” as used herein refers to a drilling operation wherein a small amount of lubricant is delivered to the location wherein the tool interacts with the substrate, i.e., a cutting or deformation zone. The amount of the lubrication is so small that during the cutting or deformation it is substantially vaporized due to the heat generated during the operation of cutting or deforming. Such machining operations may be termed ‘semi-dry’ processes.

“Substantially without lubricants” as used herein refers to a drilling operation conducted without applying any lubricants and aided only with aids such as compressed air or gas, cooled air or gas, or the like. This later process may also be referred to as ‘dry machining. For example, in one embodiment, the operation of drilling is conducted with compressed air with pressure of 5 kg/cm² is blown from a nozzle set facing the drilling position so as to blow off the chips and dissipate the heat generated during drilling.

In one embodiment, the disclosed method includes rotating a coated cutting tool made per the instantly disclosed methods against a substrate under sufficient pressure and force such that the tool creates displacement in the substrate, wherein the rotation of the drill occurs under minimum lubrication conditions or substantially without lubricants.

In another embodiment, a method of machining a nonferrous substrate with no more than minimum lubricants is disclosed. The method requires providing a diamond coated drill produced by a method comprising depositing an interlayer comprising Cr/CrN on a surface of a drill comprising WC to create a interlayer surface, peening the interlayer surface with a peening compound comprising friable diamond particles to create a peened interlayer surface, and depositing a diamond coating on the peened interlayer surface to create a diamond coated drill, and moving the diamond coated drill against a nonferrous substrate with sufficient force such that the drill displaces, i.e., cuts and removes a part of the substrate, wherein moving and cutting occurs under minimum lubrication conditions. In one exemplary embodiment, the machining will be done substantially without lubricants, while in another; the nonferrous substrate will comprise aluminum.

### COMPARATIVE EXAMPLE

A diamond coating according to the prior art was deposited on a substrate. The substrate was a polished cemented carbide substrate having a composition of 94 wt % WC and 6 wt % Co, based on the total weight of substrate. An interlayer comprising a Cr/CrN coating approximately 5 microns thick was deposited on the substrate in a PVD process. The resulting Cr/CrN interlayer was then seeded in an ultra-sound bath in a suspension of diamond particles of 1 micron in diameter. The ultrasonically prepared interlayer was then coated with a diamond coating of 10 micron thick in a PACVD process at approximately 750 degree C.

### EXAMPLE 1

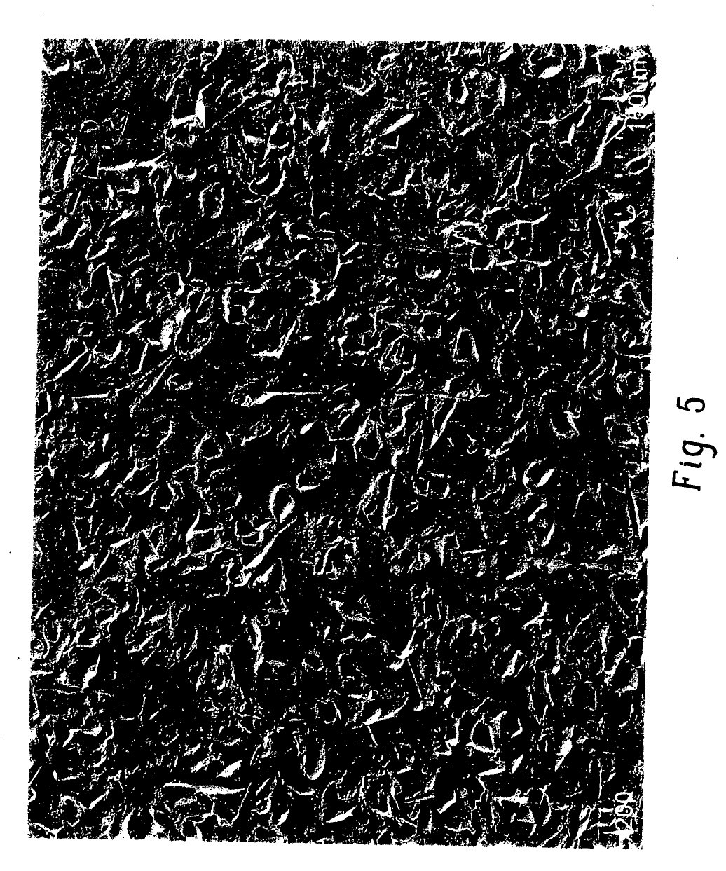

A diamond coating according to the disclosed processes was deposited on a substrate. The substrate was a polished cemented carbide substrate having a composition of 94 wt % WC and 6 wt % Co, based on the total weight of substrate. An interlayer comprising a Cr/CrN coating approximately 5 microns thick was deposited on the substate in a PVD process. The resulting Cr/CrN interlayer was then peened using diamond particles of average diameter of 75 microns for 30 seconds. The peened Cr/CrN interlayer is illustrated in the microphotograph of FIG. 5. The peened Cr/CrN interlayer was then seeded in an ultra-sound bath in a suspension of diamond particles of 1 micron in diameter.

### EXAMPLE 2

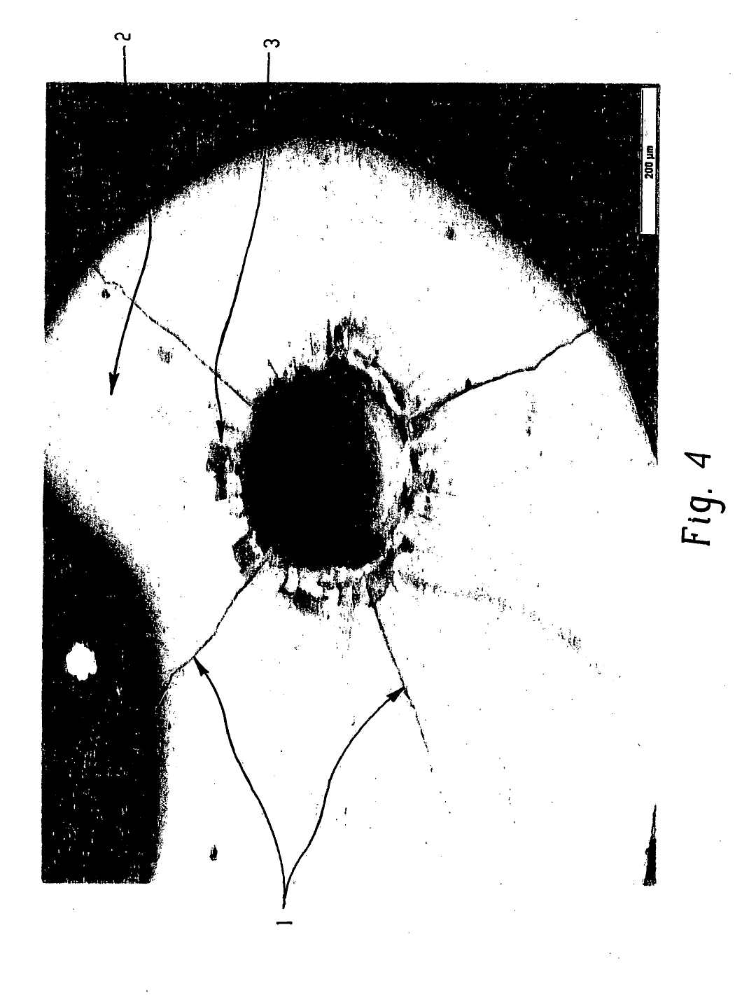

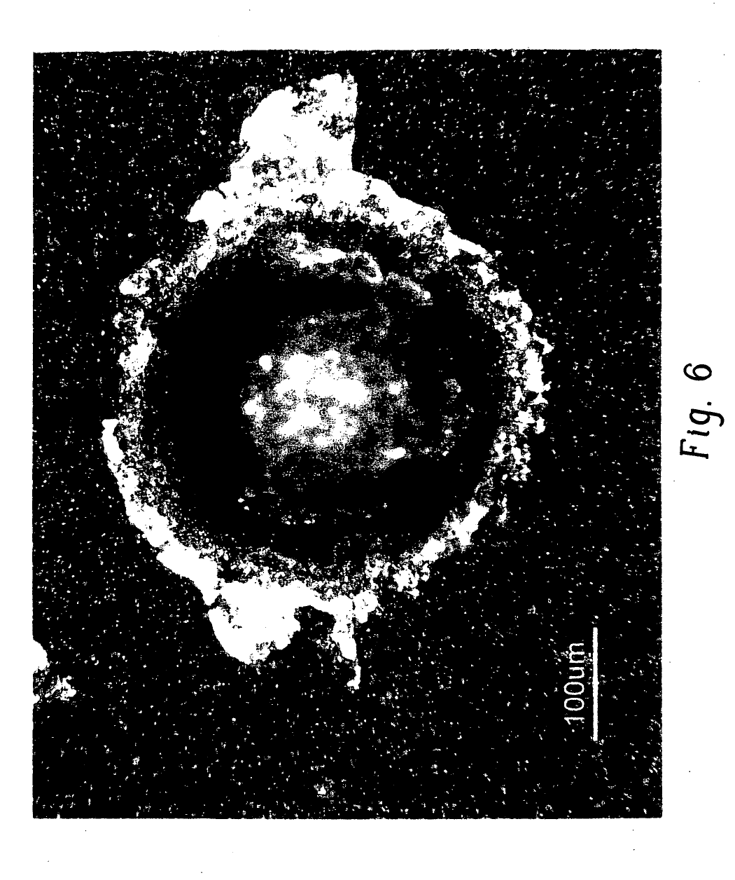

The adhesion of the coatings of the Comparative Example and Example to the substrate was evaluated by indenting each coated substrate with a Rockwell indenter, which is a standard procedure wherein a diamond indenter is driven into the coated surface with the force of 150 kg. This Rockwell indentation deforms the surface and introduces a number of defects in the substrate. The deformation induced in the substrate probes the interface between the coating and the substrate. The weaker the interface, the more coating delaminates. As illustrated in FIG. 4, the coating on the non-peened surface of the Comparative Example delaminates in the region of more than 300 microns away from the indent. Region 1 illustrates cracks in the cemented carbide substrate, while region 2 shows spalling of the diamond coating. Region 3 shows the delamination of the Cr/CrN interlayer from the WC substrate. However, as indicated in FIG. 6, the coating on the peened interlayer surface delaminates only along the rim of the indent and approximately within a 50-micron region from indent. This is an indication that the adhesion of the diamond coating to the substrate has been improved in the diamond coated substrate prepared in Example 1 according to the disclosed processes.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A method of making a coated substrate on an article, comprising
depositing an interlayer on a substrate of an article to create interlayer surface,
peening the interlayer surface with a peening compound to create a peened interlayer surface, and
depositing a coating on the peened interlayer surface to create a coated substrate,
wherein the peening compound comprises particles of the same composition as the coating.

2. The method of claim 1 wherein peening further comprises depositing particles of peening compound on the peened interlayer surface.

3. The method of claim 1 wherein the interlayer comprises at least two sub layers.

4. The method of claim 3 wherein at least one sub layer comprises a ceramic and at least one other sublayer comprises a metal.

5. The method of claim 4 wherein the ceramic sublayer is closer to the substrate than the at least one metallic subinterlayer.

6. The method of claim 1 wherein the interlayer comprises a metallic.

7. The method of claim 1 wherein the peening compound comprises friable particles.

8. The method of claim 7 wherein peening comprises accelerating the particles of the peening compound with a carrier fluid at a rate sufficient to break the particles as they strike the surface of the interlayer.

9. The method of claim 1 wherein depositing a coating further comprises depositing a coating using at least one of chemical vapor deposition (CVD), plasma assisted chemical vapor deposition (PACVD), or carbon derived carbide method.

10. The method of claim 1 wherein the coating deposited on the peened interlayer surface comprises a diamond coating and the peening compound comprises diamond particles.

11. The method of claim 1 wherein the substrate is a surface of at least one tool that is a metal cutting tool, a drill, a tap, a cutter, a metal forming tool, a metal forming die, a metal forming punch, or a casting for a liquid metal.

12. A method of making a coated substrate on an article, comprising
depositing an interlayer on a substrate of an article to create interlayer surface,
peening the interlayer surface with a peening compound to create a peened interlayer surface,
peening the peened interlayer surface with another peening compound to create a repeatedly peened surface, and
depositing a coating on the repeatedly peened surface to create a coated substrate.

13. The method of claim 12 wherein the peening of the peened interlayer surface is repeated more than once.

14. An article having a coated substrate made by the method of claim 1

15. The coated article of claim 14 that is a diamond coated cutting tool

16. The coated article of claim 15 that is a diamond coated cutting tool that is at least one of a drill, a tap, a cutter, a metal forming tool, a metal forming die, a metal forming punch, or a form for casting for a liquid metal.

17. A method of machining a nonferrous substrate with no more than minimum lubricants, comprising
providing a diamond coated machining tool made by the method of claim 1, and
moving the tool against a nonferrous substrate with sufficient force such that the tool cuts and removes a part of the substrate,
wherein the moving of the tool against the substrate occurs under minimum lubrication conditions.

18. The method of 17 wherein the substrate comprises at least one of aluminum, aluminum-containing alloys, magnesium, magnesium-containing alloys, graphite.

19. The method of 17 wherein the tool is a drill

20. The method of claim 17 wherein the diamond coated drill was produced by a method comprising
depositing an interlayer comprising Cr/CrN on a surface of a drill comprising WC to create a interlayer surface,
peening the interlayer surface with a peening compound comprising diamond particles to create a peened interlayer surface, and
depositing a diamond coating on the peened interlayer surface to create a diamond coated drill.
